(19) United States
(12) Patent Application Publication
(10) Pub. No.: US 2025/0181845 A1
(43) Pub. Date: Jun. 5, 2025

(54) Automated Use of User Input to Improve AI Generation of Database Objects with Reduced Computational Cost and Reduced Model Hallucination

(71) Applicant: ServiceNow, Inc., Santa Clara, CA (US)

(72) Inventors: Sanket Tantia, Hyderabad (IN); Varun Tayal, Hyderabad (IN); Harshvardhan Prasad, Hyderabad (IN); Kartik Aysola, Hyderabad (IN)

(21) Appl. No.: 18/526,863

(22) Filed: Dec. 1, 2023

(51) Int. Cl. G06F 40/40; G06F 16/215

(52) U.S. Cl. CPC G06F 40/40; G06F 16/215

(57) ABSTRACT

Embodiments are provided herein that include receiving, from a natural language model and based on a first textual prompt, a first output that represents a database entry, wherein the database entry includes a plurality of elements; obtaining a selection of a subset of the plurality of elements; determining a second textual prompt based on the selected subset of the plurality of elements; and generating, via the natural language model, a second output based on the second textual prompt, wherein the second output represents an update to the database entry. These embodiments provide for faster generation of catalog items or other types of database entries using generative natural language models in a manner that exhibits reduced memory requirements, computational cost, and/or amounts of training data.

### BACKGROUND

Database entries that represent sets of user inputs or other information relevant to common user requests or needs within a managed network or other system can be generated. However, such a process can take a great deal of time. This can be particularly true where a requestor is ambiguous about their requirements for a new database entry as described herein, leading to multiple iterations of development of the database entry as the developer and requestor communicate. Alternatively, large language models (LLMs) or other generative natural language models could be used to generate such database entries. However, such models can be prone to errors (e.g., hallucinations) in the generated database entries and can be computationally expensive to execute. Further, it can be difficult to insert requestor feedback into such a model-based database entry generation process.

### SUMMARY

It is advantageous to create entries in a database that represent sets of user inputs or other information relevant to common user requests or needs. For example, such entries could represent the specification information a user might provide, or the identity and timing of servers or services to which a user might request access. Such database entries can then be used to generate individual request records representing respective user requests. The database entries can specify the information and format of the user requests as stored on the database, and can also specify downstream tasks (e.g., administrator approval, requisitioning, updating user access or credentials) necessary to satisfy the user needs represented by the individual requests. Indeed, the use of such database entries to generate user requests according to a specified format can allow some or all of the tasks necessary to satisfy those requests to be performed in an automated or semi-automated manner, e.g., by a computing environment automatically updating a user's credentials to grant them access to a server or other system and/or generating the request. User interfaces to obtain the necessary information to generate such requests can also be automatically generated from such database entries.

The embodiments described herein provide improved natural language model generation of such database entries, reducing computational cost and the incidence of hallucinations or other errors in the generated database entries. These benefits are provided by breaking up the database entry generation process into multiple steps or stages, thereby allowing for requester feedback to be injected into the entry generation process in a computationally inexpensive manner. A first input from a requestor is converted into a first prompt that is applied to a natural language model to generate a first output that represents the database entry. The database entry is organized as multiple elements, including a description of the database entry as well as a number of other elements (e.g., pieces of input information needed to define a user request, steps needed to satisfy a user request), each element having at least a type (e.g., “text,” “date,” “numeric”) and a description (e.g., “server IP address,” “duration of access requested”). The requestor can then select one of the elements for modification or deletion (e.g., “add a description of this element,” “add a regular expression for validation of this input”). A second prompt is then generated based on the selection and applied to the generative natural language model to generate a second output that represents the database entry with the selected element modified or deleted. The database entry can then be updated according to the second output to implement the requestor's feedback.

The embodiments described herein also provide for improved training of such a generative natural language model. This is accomplished by using an initial generative natural language model to generate a plurality of database entries. These database entries can then be used, alone or in combination with manually-generated database entries, to train an updated version of the generative natural language model. The reduced time necessary to generate database entries using the methods described herein lead to an increased number of available database entries for such training, and at a lower cost. Additionally, such machine-generated database entries are superior for use in training the generative natural language model since they are likely to differ with respect to prose, style, or other irrelevant aspects than manually-generated database entries (which may be generated by many different human developers). Thus, the use of such machine-generated database entries for training allows the model being trained to focus on relevant aspects of the database entries, rather than attempting to extract useful information from differences between the style and prose of different human developers.

Accordingly, a first example embodiment may involve a method that includes: (i) receiving, from a natural language model and based on a first textual prompt, a first output that represents a database entry, wherein the database entry includes a plurality of elements; (ii) obtaining a selection of a subset of the plurality of elements; (iii) determining a second textual prompt based on the selected subset of the plurality of elements; and (iv) generating, via the natural language model, a second output based on the second textual prompt, wherein the second output represents an update to the database entry.

A second example embodiment may involve a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts aspects of a user interface, in accordance with example embodiments.

FIG. 6B depicts aspects of a user interface, in accordance with example embodiments.

FIG. 6C depicts aspects of a user interface, in accordance with example embodiments.

FIG. 6D depicts aspects of a user interface, in accordance with example embodiments.

FIG. 6E depicts aspects of a user interface, in accordance with example embodiments.

FIG. 6F depicts aspects of a user interface, in accordance with example embodiments.

FIG. 6G depicts aspects of a user interface, in accordance with example embodiments.

FIG. 6H depicts aspects of a user interface, in accordance with example embodiments.

FIG. 6I depicts aspects of a user interface, in accordance with example embodiments.

FIG. 6J depicts aspects of a user interface, in accordance with example embodiments.

FIG. 6K depicts aspects of a user interface, in accordance with example embodiments.

FIG. 6L depicts aspects of a user interface, in accordance with example embodiments.

FIG. 7A depicts aspects of a user interface, in accordance with example embodiments.

FIG. 7B depicts aspects of a user interface, in accordance with example embodiments.

FIG. 7C depicts aspects of a user interface, in accordance with example embodiments.

FIG. 8 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

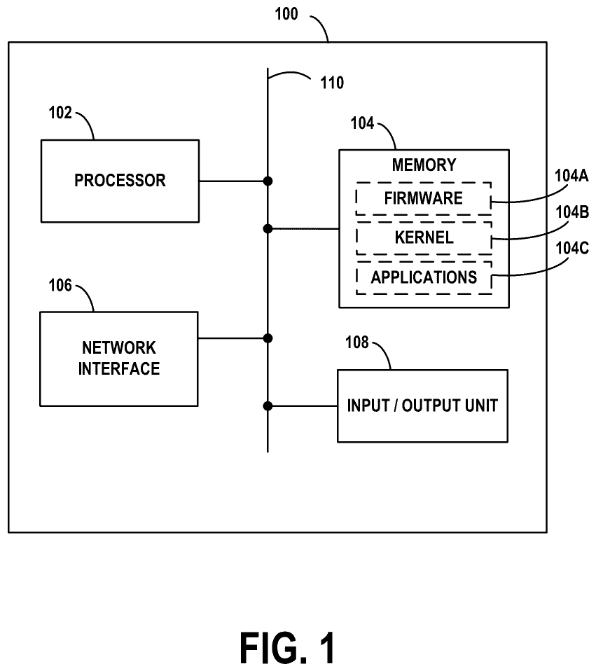

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

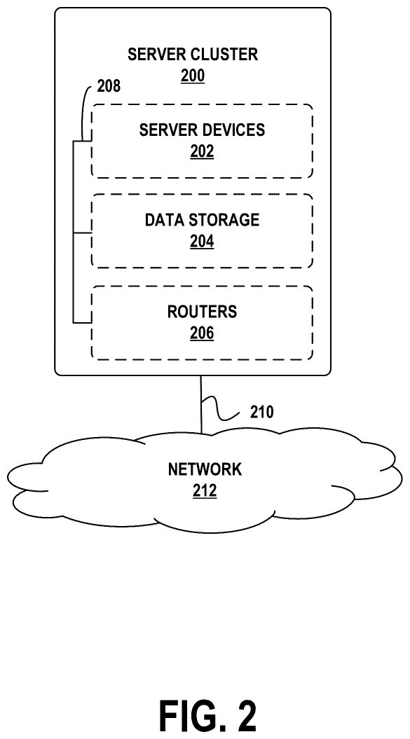

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

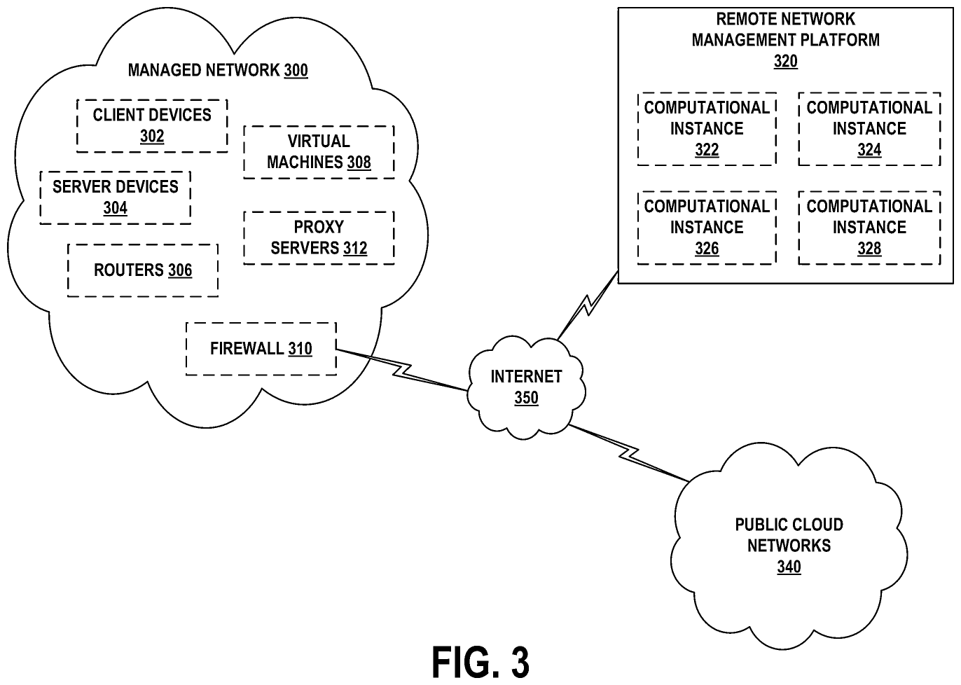

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

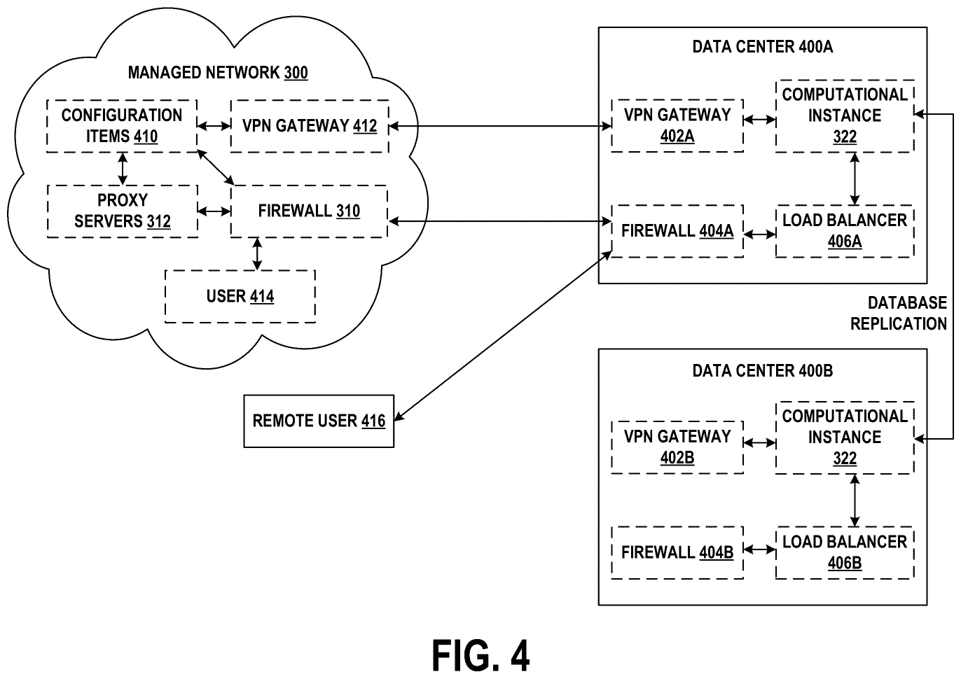

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

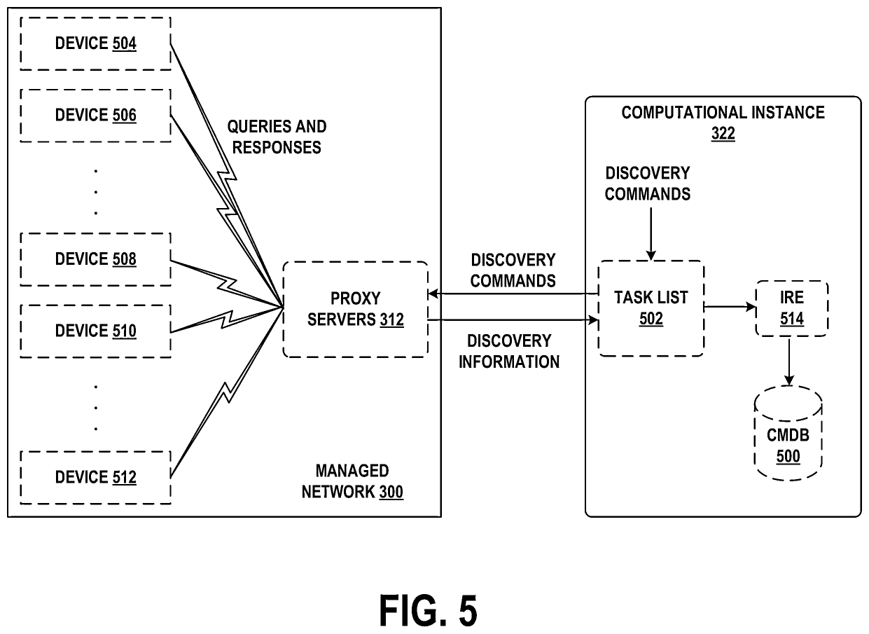

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Example Generative Model Generation of Database Objects

The operation of a managed network or other computerized system can be facilitated by using databases to describe the operation, configuration, and status of the system, with the database being updated to reflect changes in the underlying system. The information in the database can then be used by humans and/or by automated systems to organize and perform the activities of the system. This can include the use of separate request records in the database to represent sets of inputs from users about user needs relative to the operation of the system. Such requests can be generated according to database entries describing the contents of such requests, e.g., “catalog items” that represent different credentials, system access, software, hardware, or other resources that a user might need as part of their work with the system.

Such database entries can include representations of information that a user must and/or may optionally provide to describe the particulars of the requested resource, e.g., the identity of a server to which access is requested, the duration of the requested access, and the reason for the request. Such entries can also represent steps to be taken in order to provide the requested resource. The representation of the set of information about such a request as an entry in a database can facilitate the operation of the system by allowing the information for individual requests to be organized in a single location (a database record generated according to the pattern and procedure specified in the database entry) and in a known format to enable automated systems and/or human technicians to efficiently address the user request represented thereby (e.g., by generating a ticket in a ticketing system for later human/automated fulfillment).

The representation of the set of information about such a request as an entry in a database can also allow a user interface (e.g., HTML defining a hardware, software, or access request interface) to be automatically generated in order to generate request record(s) based on user inputs received via such automatically-generated user interfaces. For example, such a database entry could include a plurality of elements, e.g., a title and short summary of the database entry for display in a catalog of such database entries, a long form description of the contents and/or purpose of the database entry, input elements that define user inputs and related information (e.g., descriptions of the user inputs and/or instructions on how to provide the inputs, regular expressions or other information to sanitize user input prior to storage as a database record, information about a text box, radio button, set of enumerated options, or other information defining a user interface to receive the user input), satisfaction steps that define elements of a process to satisfy individual user requests represented by request records, or other elements. In such an example, a system could use the information in the database entry to automatically generate a user interface to, e.g., allow a user to provide all of the inputs specified by the elements of the database entry, to read a long-form description of the database entry, or to otherwise obtain information about the database entry, to cause request record(s) to be generated according to the pattern and procedure specified in the database entry, or to accomplish some other objective related to the database entry.

Generation of database entries can be time-intensive, especially where the database entry is being created according to an ambiguous specification, resulting in multiple iterations of development and specification update. Additionally or alternatively, generative natural language machine learning models, like large language models (LLMs), could be used to allow generation such database entries by inputting free-form textual descriptions of aspects of the desired database entries. Such textual descriptions can then be used to generate prompts (e.g., by appending a description of a target database entry format to the free-form textual description) that are then applied to the generative models to generate outputs that are then used (e.g., parsed) to create the database entries. However, the use of such generative models in such a manner can be prone to hallucinations or other errors, and can also be very computationally expensive to execute.

Additionally, while such a process allows non-developers to initiate the database entry generation process, it is difficult to then allow such non-developer users to adjust the output database entries or to otherwise incorporate their feedback into such a database entry generation process. For example, such a user could provide free-from textual feedback describing an update to the database entry which could then be used, in combination with some or all of the initial prompt and/or the database entry, to generate a second prompt that is applied to the model to create a second, updated database entry. However, such a process can result in updated database entries that are improved with respect to the aspects described in the textual feedback, but diminished in other respects that the user found acceptable in the original database entry. Additionally, such a process of completely re-generating the database entry in order to incorporate user feedback is computationally expensive.

The embodiments described herein provide improvements with respect to these issues. These embodiments include obtaining a first user input (e.g., a name of a desired catalog object for which a database entry can be generated) from which can be generated a first textual prompt (e.g., by adding the text of the first user input to default text or other default prompt content specifying a format in which to generate outputs so as to facilitate parsing of the outputs into database entries). This first textual prompt is then applied to a natural language model (e.g., a large language model) or other generative model to generate a first output that represents a database entry. The model and/or first textual prompt are specified such that the database entry may include a plurality of elements. Such elements could include a long and/or short (e.g., summary) description of the database entry, elements corresponding to inputs to be obtained from a user in order to generate a request record according to the database entry (e.g., inputs that specify properties of a piece of hardware or software, requests for which can be generated according to the database entry), elements corresponding to steps that can be taken to fulfill a request generated according to the database entry, and/or some other elements.

Representing such database entries as pluralities of separate entries allows further user input (or other types of update or modification) to be applied to update only specified elements (e.g., single elements) of an already-generated database entry. This prevents non-selected elements of the database entry, which may already comport with user preferences, from being updated in ways that may make those elements worse (e.g., by including hallucinations or other unwanted content, due in part to the selected element(s) being the focus of such a whole-database entry update). A second textual prompt is generated based on the selected element(s) and applied to the natural language model or other generative model to generate a second output that represents an update to the database entry. Such a second output could represent modifications to the selected element(s) of the entry, deletion of the selected element(s), or some other modification to the database entry. The second output could then be parsed or otherwise used to update the database entry.

Such element-wise updating of model-generated database entries is beneficial because it allows specific user feedback to be incorporated into a model-based database entry generation process without requiring regeneration of the entire database entry to incorporate the feedback. Such element-wise generation of database entry updates can also result in reduced computational cost, as the computational cost to generate update model outputs for single elements or sets of elements may be less than the cost to re-generate the complete database entry (e.g., a smaller model could be employed, or an iterative or otherwise multi-step model may be executed fewer times to generate outputs to update sets of element(s) of a database entry, relative to generation or re-generation of the complete database entry). Indeed, even in examples where the user feedback is simply to “re-generate” a selected set of elements, without any additional feedback as to how to perform such re-generation, the computational cost may be reduced compared to the cost of re-generating the entire database entry. Further, as noted above, the updated database entry is likely to be improved as the non-selected elements thereof will not be deleteriously modified by such a selective update process.

Such element-wise updating of model-generated database entries can also be used to reduce the computational cost of generating such database entries and/or to improve the quality of the generated database entries within a specified compute budget (e.g. a specified total cycle cost, maximum model memory footprint, total model execution time), even in the absence of user feedback to update/re-generate the database entry. This can include, as described above, generating a first prompt that, when applied to the natural language model, provides a first output that is used to generate the database entry, which includes a plurality of elements. Additional prompts can then be generated, one for each of the elements of the database entry, to re-generate, elaborate, or otherwise modify the respective elements of the database entry. The outputs of the model, in response to input of the additional prompts, can then be used to update the respective elements of the database entry. In this way, a smaller, computationally less expensive model can be used (e.g., that include fewer parameters, that includes fewer layers, that includes performing an iterative or other serial process fewer times) to generate the initial database entry and/or the outputs to update the individual elements thereof, since the model does not need to be capable of generating information about fully-realized versions of each of the elements in a single execution. Instead, the model only needs to be able to generate. The first prompt, used to initially generate the database entry, could be tailored to focus the effort of the model on generating a list of elements or some other limited, summary information about each of the elements of the database entry (e.g., “generate a list of elements of a database entry titled $UserInput”). The additional prompts could then include the respective names of the listed elements and/or respective summary information generated therefor by the model from the first prompt.

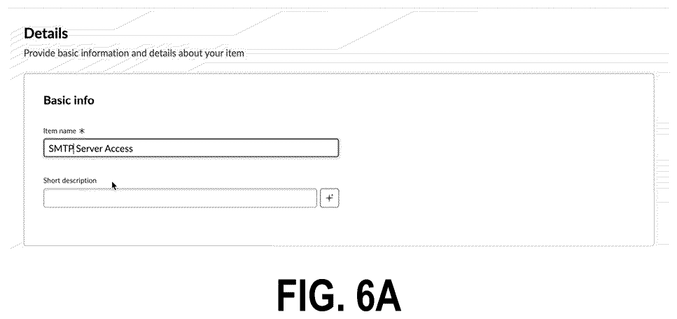

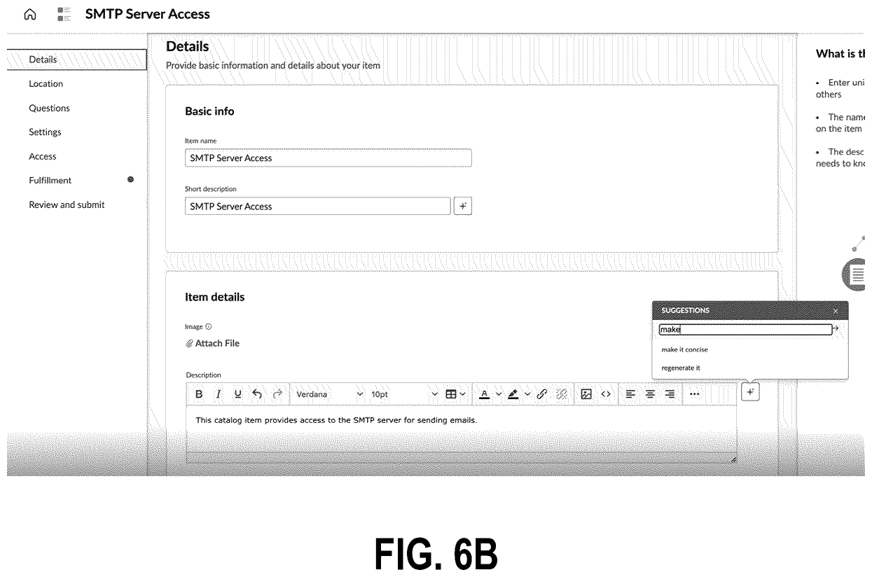

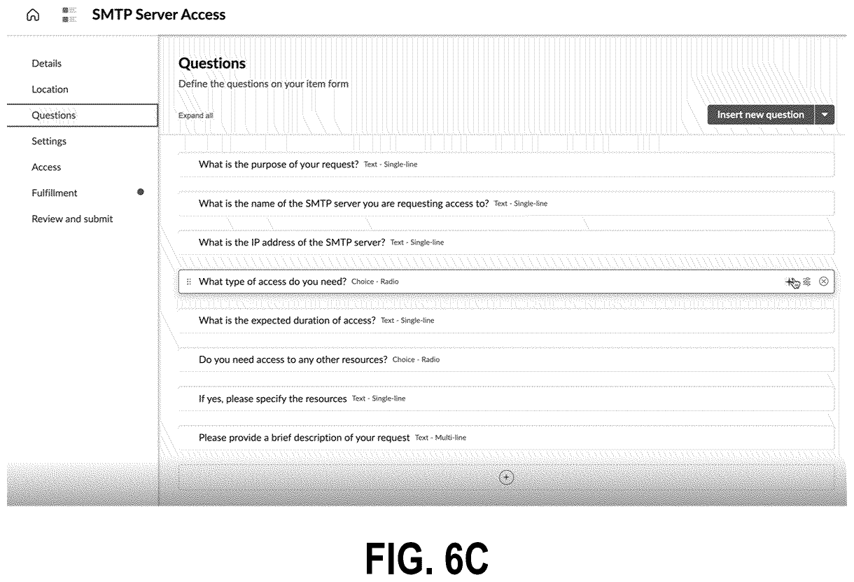

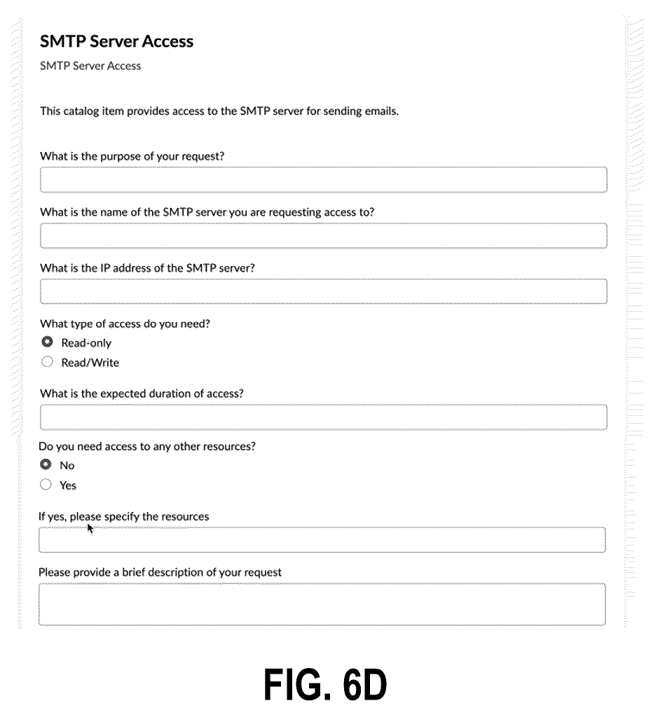

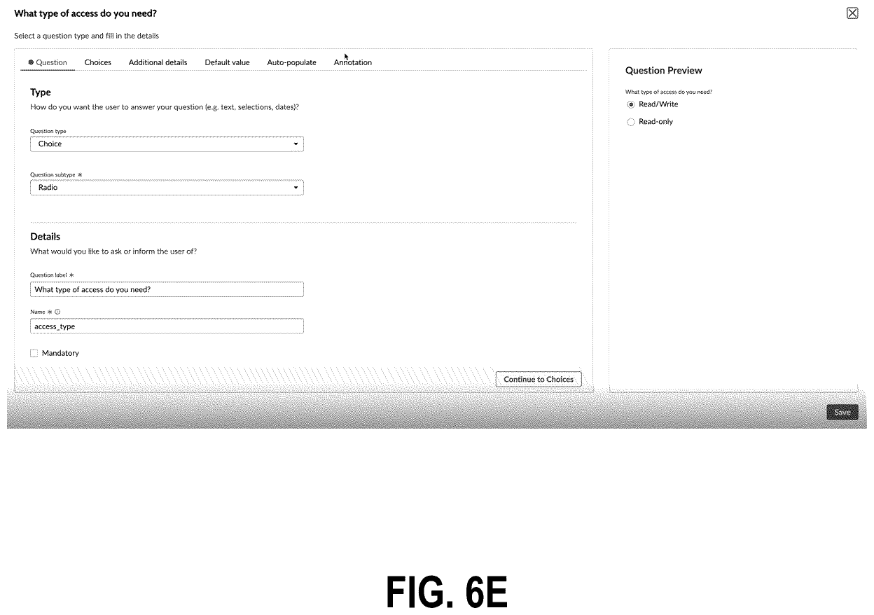

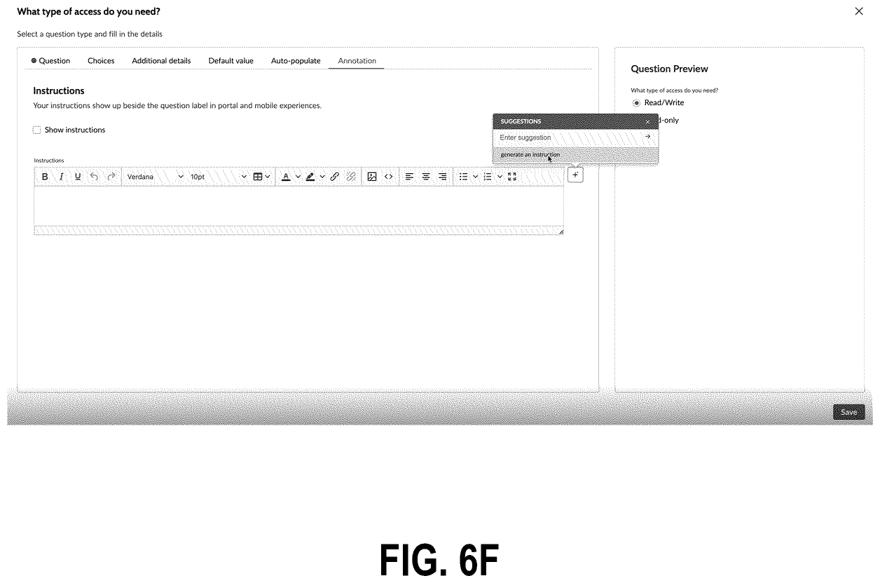

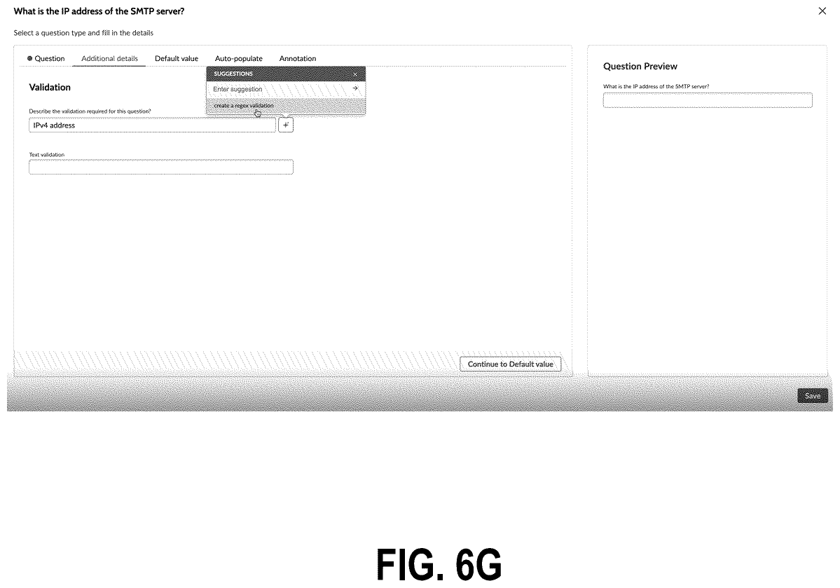

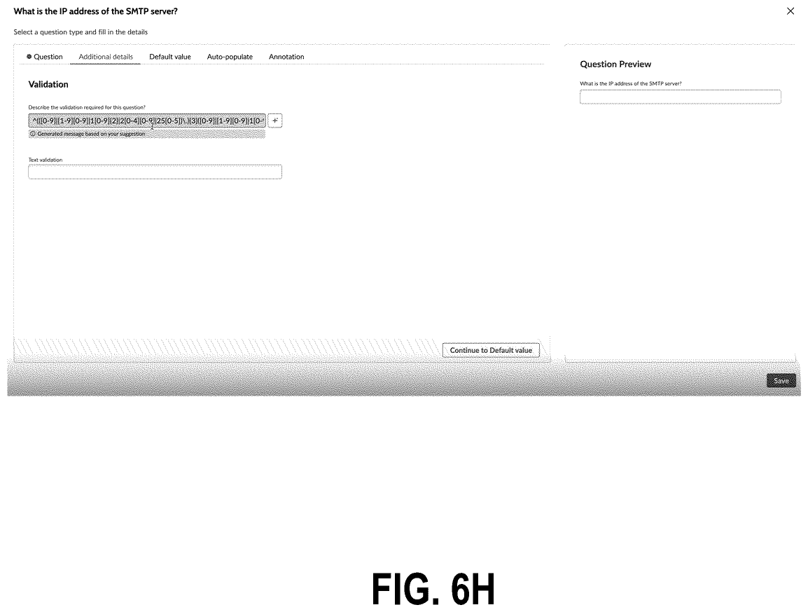

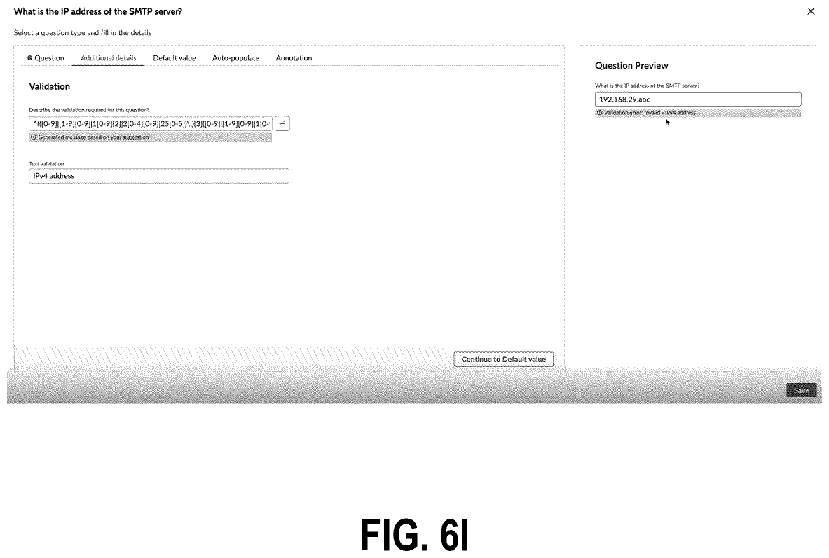

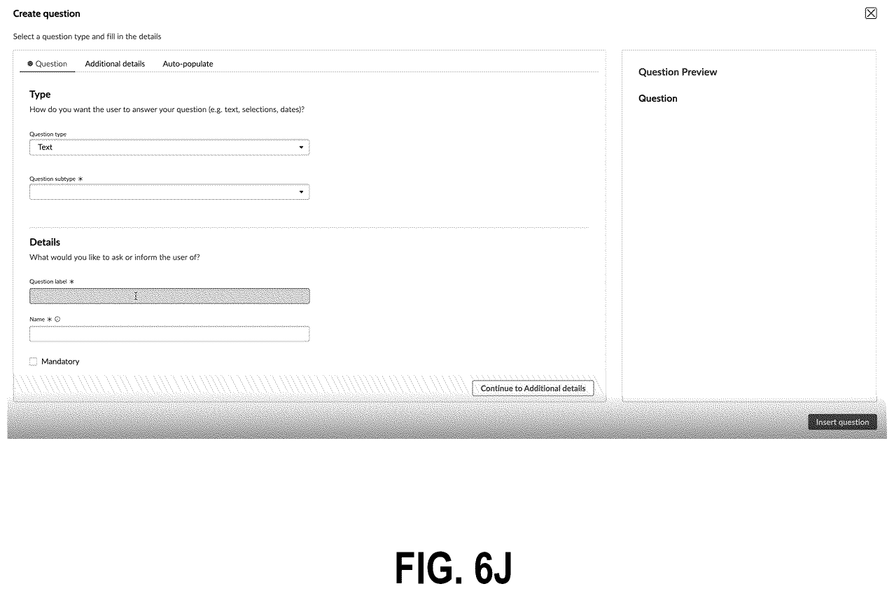

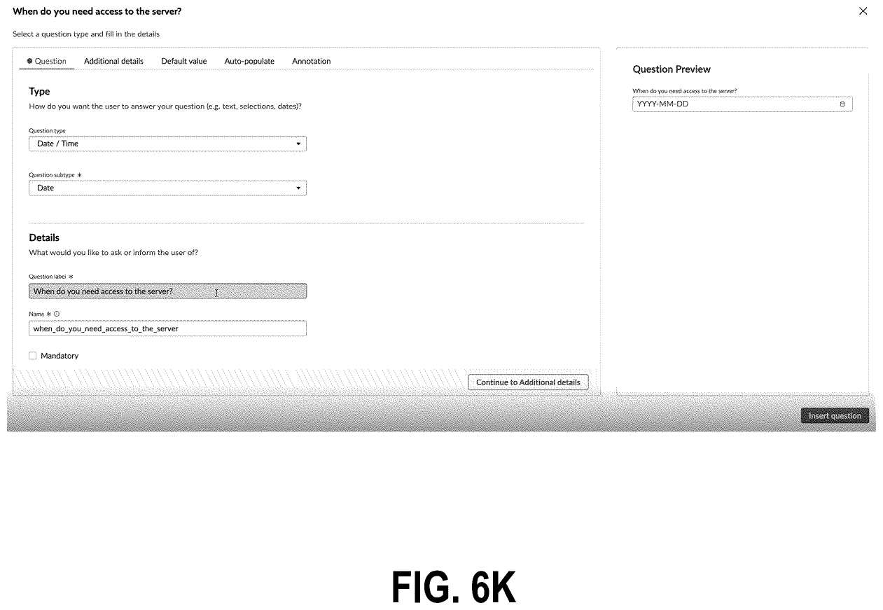

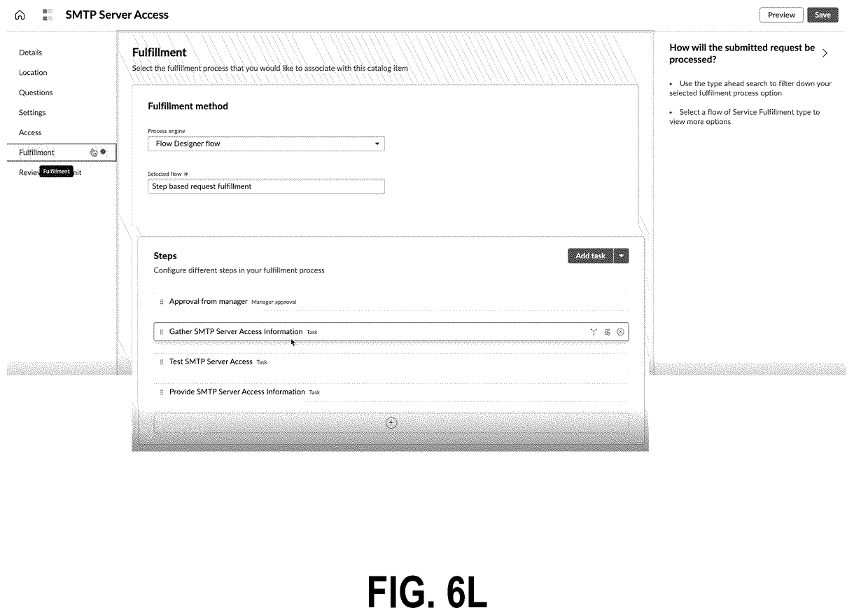

FIG. 6A depicts aspects of an example user interface that a user could use to generate a database entry as described herein. As shown, the user interface includes a text box into which the user can input text representing the name of the desired database entry (e.g., “New Laptop Request,” “Server Access Request,” “Credential Elevation Request,” “User Name Change,” “User Address Change,” “Computer Upgrade Request,” “Software Request”). In the example of FIG. 6A, the user has input “SMTP Server Access” (here, SMTP may represent the simple mail transfer protocol, which is used for sending and receiving email messages among other features). This input can then be used to generate a first textual prompt (e.g., by concatenating the user-input text “SMTP Server Access” with additional text instructing a model to generate an output representing a multi-element database entry with such a name, additional text specifying a format according to which to generate the output in order to facilitate parsing the output, or some other additional text). Such a first textual prompt can then be applied to a natural language model to generate a first output that is representative of the requested database entry (e.g., that represents the database entry in a JSON format or according to some other format as specified by text in the first textual prompt).

The generation of the first textual prompt and application thereof to the natural language model to generate the first output could be performed automatically (e.g., in response to the user not inputting additional text for a specified period of time) and/or in response to a user input (e.g., a carriage return, a user clicking on a pop-up button or tooltip). In some examples, the user could also provide text as a “short description” for the database entry, with the “short description” and “item name” both being used to generate the first textual prompt. Additionally or alternatively, the natural language model could be used to generate the “short description” based on the “item name” (e.g., in response to the user clicking the star button in the interface depicted in FIG. 6A) which could then be used (following optional user modification thereof), in combination with the “item name,” to generate the first textual prompt.

The generated database entry may include a plurality of elements. Each element may represent a different aspect of the database entry. The elements could include, e.g., summary descriptions of the database entry (e.g., for use in a catalog of database entries), long-form descriptions of the database entry (e.g., documentation describing the database entry, prerequisites for use or implementation of the database entry, information about relationships with other database entries), inputs to receive from a user in order to generate individual request records from the database entry (e.g., requestor name, a time when the requested item is needed, a duration that a requested access is needed, hardware or software specs of a requested physical resource), steps to take to effect a request record generated from the database entry (e.g., a list of individuals from which to receive authorization, hardware or software configuration steps), or some other elements of a database entry as described herein. Each entry could include information related to the element. For example, an input element could include a name of the input (e.g., “Server IP”), input sanitization criteria for the input (e.g., a specification that the input be an integer or a regular expression that the input must satisfy), information about a type of the input and/or how to receive the input from a user (e.g., as radio buttons or a drop-down menu to select between an enumerated set of possible input values/states that are also specified by the element, a free-form text box, a text box with slashes to enforce calendar date formatting of the input), long-form instructions for providing the input (e.g., that may be provided as a pop-up in response to mouse-over of a corresponding portion of an input user interface or some other interaction with the input user interface).

A user interface could be provided to permit a user to interact with such elements of a database entry and to modify them. Such modification could include selecting sets of one or more of the elements and using the natural language model to update or otherwise modify the selected elements (e.g., by deleting one or more of the selected elements, by adding one or more additional elements, by editing text or changing other aspects of the selected elements, by re-generating, elaborating, or otherwise modifying the selected element(s) using the natural language model). This could include generating one or more additional textual prompts based on the selection (e.g., based on the selection alone, or based on the selection and associated free text or other user input(s)). The database entry could then be updated based on the resulting output from the model (e.g., the selected element(s) could be updated based on information parsed from the model output).

FIG. 6B depicts aspects of a user interface that could allow a user to select elements of a database entry for modification, e.g., using a natural language model. As shown in FIG. 6B, a variety of different classes of elements of the database entry can be selected via the options listed in the left pane of the user interface; as shown in FIG. 6B, the “Details” class, which includes “Item Name,” “Short Description,” and “Item Details” elements, has been selected for display and possible modification. The user has specifically selected the “Item Details” element, which provides a long-form description of the database entry, by clicking the star button in order to access options for using the natural language model to modify the “Item Details” element. Additionally or alternatively, the user could directly edit the content of the “Item Details” element using the user interface. Clicking the star button has provided the user with several enumerated options for model-mediated modification of the contents of the “Item Details” element (“make it concise” or “regenerate it”), as well as an option to input free-form text to instruct the model as to how to modify the contents of the selected “Item Details” element. The use of a natural language model allows such free-form textual input to be easily ingested by the model, e.g., by inserting such text into a textual prompt that is then applied to the model.

As shown in FIG. 6B, the user as entered “make” into the free-form text box, as part of entering “make it elaborative” in order to instruct the model to generate an output that can be parsed to elaborate the contents of the “Item Details” element (e.g., by replacing the contents of the Item Details” element with the model output). Generating a textual prompt from the user's selection and other inputs (e.g., the free-form textual input, the selection of one of the enumerated options) can include concatenating the user's free-form textual input, or the text of a selected enumerated option, with other textual information (e.g., text specifying a format for the output, text or code representing the current contents of the selected “Item Details” element to inform the model of the state of the selected element prior to the user's selection thereof). In some examples, the enumerated options of such a user interface may be model-generated themselves, e.g., provided as part of a model output that specified the database entry as a whole and/or the specific selected element (i.e., the “Item Details” element in the example depicted in FIG. 6B). Additionally or alternatively, such enumerated options may be generated by an human-coded algorithm (e.g., always including an option to “regenerate it,” input elements having a type of “date,” “number,” address,” or similar algorithmically sanitize-able types always having an option to “generate regular expression for input sanitization”).

FIG. 6C depicts aspects of the user interface that could allow a user to select elements of a “Questions” class of the database entry for modification, e.g., using the natural language model. As shown in FIG. 6C, each element can be represented in the user interface with a variety of summary information, e.g., the text that will be provided to a user to evoke the input (“What type of access to you need?”), the type of the input (“Choice,” Text,” etc.), and how to format a user interface element to receive the input from the user (“Radio” button, “Single-line” text, “Multi-line” text). This database entry modification interface also includes elements to employ a natural language model to modify selected elements (the star button), to manually modify aspects of selected elements (the sliders button), or to delete selected elements (the X button). FIG. 6D depicts aspects of a user interface that could be generated, using a database entry as described in relation with FIGS. 6A-C, to obtain from a user the information necessary to generate a corresponding request record according to the pattern specified by the database entry. The database entry specifies the information needed, any input sanitization to be applied to the inputs, text descriptions and optionally pop-up instructions for each of the inputs, the type of each of the inputs, lists of the available options for inputs that represent selections between enumerated sets of options, information about the manner of providing a user interface to obtain the information from a user, and optionally additional (or less) information for each of the inputs in an element-wise fashion.

FIG. 6E depicts aspects of the user interface that could allow a user to modify a particular element (the “What type of access do you need” element within the “Questions” class of elements) of the database entry for modification, e.g., using the natural language model. A user can modify such aspects of the particular element, e.g., by manually changing various aspects of the element. For example, the user could change the question type, question subtype, question label, name, or other aspects of the particular element. As depicted in FIG. 6E, aspects of the particular element within the “Question” tab are shown; the user interface allows the user to select other aspects of the particular element for viewing and/or modification by clicking on the tabs at the top of the user interface. Note that such an organizational structure is optional; it could be for some or all elements of a database entry as described herein, the user interface displays all of the available aspects of the element for viewing and/or modification in a single tab/window. Note further that this organization may be specified by the natural language model output that was originally used to generate the database entry and/or to specifically generate one or more elements thereof separately from the initial database entry generation. The user interface also provides a preview of the question as it will be presented to users when using the database entry to generate request records therefrom.

The user interface may allow a user to modify some or all of the aspects of the particular element using the natural language model. For example, FIG. 6F depicts the user interface with the aspects of the particular element within the “Annotation” tab shown. The user interface provides a text box to permit a user to manually create and/or modify this aspect of the particular element. The user interface also allows the user to use the natural language model to create, re-generate, and/or modify the displayed aspect of the particular element. This facility is provided by the star button, which has a functionality similar to the functionality of such star buttons elsewhere herein. For example (as depicted in FIG. 6F), pressing the star button brings up a pop-up menu allowing a user to input free-form text, or to select one of an enumerated set of pre-existing text options, to be used to generate a textual prompt that is applied to the natural language model in order to obtain output therefrom that can be used to update the particular element. Note that the use of the star button herein is intended as a non-limiting example embodiment; a user interface or other embodiments as described herein could provide other types of buttons, or other types of user interface elements or operations (e.g., right-clicking, clicking with a function key depressed), in order to provide the user with the functionality of the natural language model in updating the database entry.

Such model-based assistance may be provided to create, modify, or otherwise update any element, or aspect of an element, of a database entry as described herein. For example, the natural language model could be used to generate input sanitization information (e.g., regular expressions, mathematical formulas, database lookups) for input elements of the database entry. For example, FIG. 6G depicts the user interface with the aspects of the particular element within the “Additional Details” tab shown, which includes aspects of the particular element related to input sanitization (“Validation”). The user interface provides a text box to permit a user to manually create and/or modify the input sanitization applied to inputs received via this element (e.g., as a regular expression). Alternatively, as shown in FIG. 6G, the user can instead input a free-text description of the desired functionality of the input sanitization (e.g., to verify that the input is in the format of an IPv4 address). The user interface then allows the user to use the natural language model to create an input sanitization function according to the desired functionality as represented by the input free text. For example, FIG. 6G depicts the user clicking “create a regex validation,” which results in a textual prompt being generated that includes the textual command to “create a regex validation” and the free-text description of the desired functionality of that input sanitizing regular expression (“IPv4 address”). This textual prompt is then applied to the natural language model and the output used to update the input sanitization for the particular element.

FIG. 6H depicts the result of such an operation. A regular expression that can verify whether an input corresponds to the format of an IPv4 address has been generated and input as the relevant aspect of the particular element. As noted before, the user interface can also provide a “question preview” functionality to allow the user to verify that the input sanitization is operating correctly (e.g., as depicted in FIG. 6I, that the incorrectly formatted text input “192.168.29.abc” is not correctly formatted, at least according to the output of the model-generated regular expression).

The embodiments described herein are not limited to modifying existing database entry elements. These embodiments can also be used to assist a user in generating additional elements to those that are already part of the database entry (e.g., in addition to those generated by a human developer and/or by parsing the output of a natural language model). This can include textual prompts being generated based on user inputs, in response to explicit user requests therefor, which are then used to generate and/or modify new elements of a database entry. Additionally or alternatively, such model-based element updating may occur automatically, without explicit user input therefor, based on ongoing user actions/inputs in relation to the new element of the database entry. For example, FIG. 6J depicts a user interface to begin modifying a new, largely empty element of a database entry. In response to a user providing some initial information about the new element, a textual prompt could be automatically generated therefrom and applied to the natural language model. The resulting output of the model can then be parsed to update the element. The results of such a process are depicted in FIG. 6K, where the user entering “When do you need access to the server?” into the “Question label” text input results in a model output being generated therefrom that updates the other aspects of the new element to match that input.

During the database entry generation process, additional types of elements may be generated for the database entry using the natural language model. For example, elements of the database entry may be generated that represent steps to satisfy requests generated using the database. Such steps may be generated during initial database entry generation (e.g., with the input elements or other elements originally generated) and/or generated following the generation and/or user modification of such elements. For example, generation of such fulfillment step elements may be accomplished by generating a textual prompt that includes a representation of the remainder of the database entry (e.g., a list of the existing elements of the database entry and/or information about the contents of such elements). The user interface and other embodiments described herein may be used to update such fulfillment elements based on user input, e.g., based on user selection(s) of elements to re-generate, elaborate, or otherwise modify such elements using a natural language model. FIG. 6L depicts aspects of such a user interface that can be used to create, delete, or otherwise modify such fulfillment elements of the database entry.

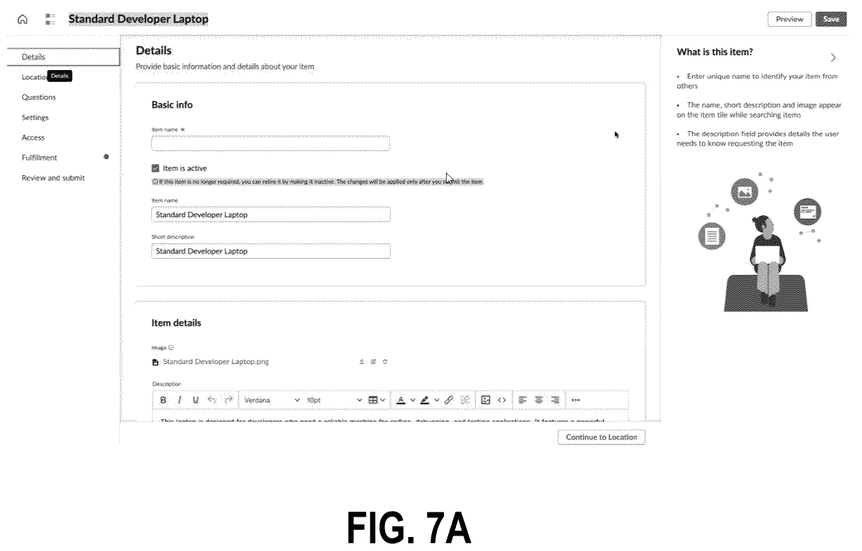

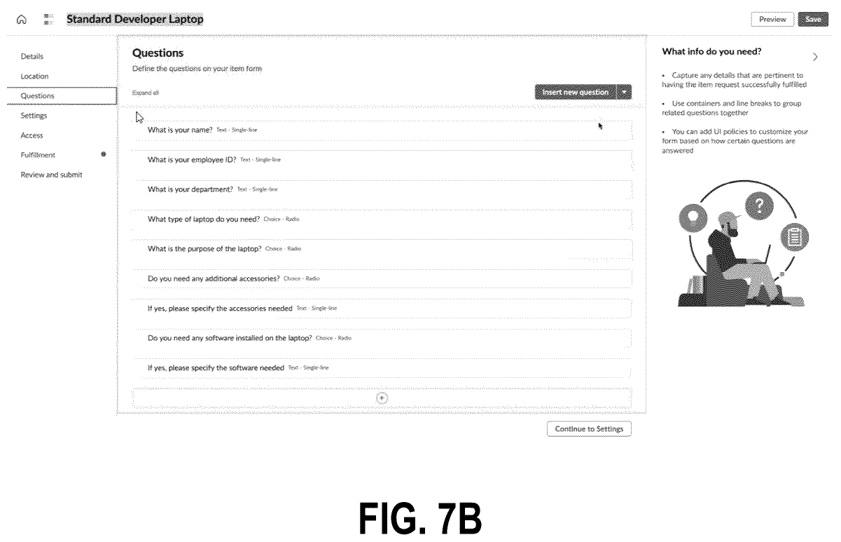

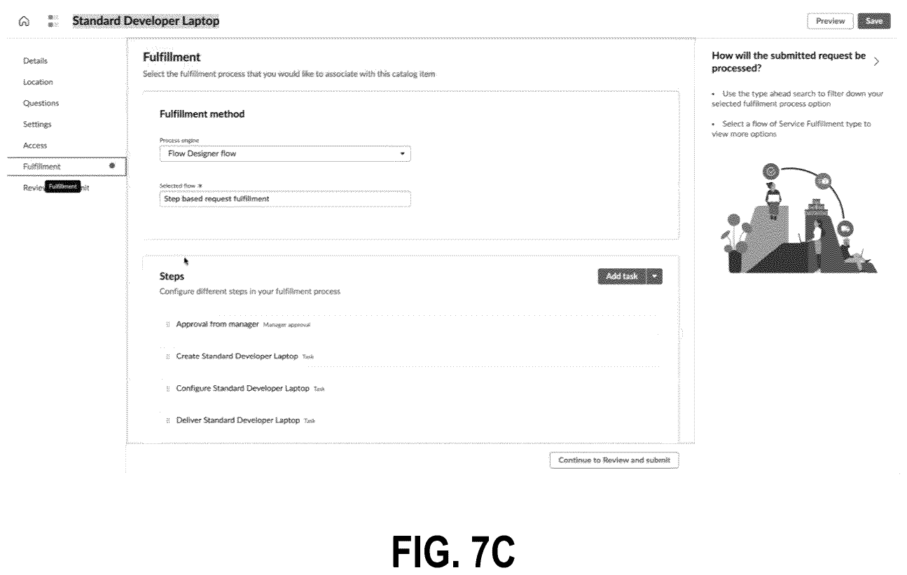

FIGS. 6A-L depict, by way of example, the use of user interfaces and other embodiments to generate a database entry that can be used to collect information and generate request records relating to user requests for access to a server or other service. Such embodiments can also be used to generate database entries that can be used to collect information and generate request records relating to user requests for hardware or software and/or modifications thereof. FIGS. 7A, 7B, and 7C depict an example of the use of user interfaces and other embodiments to generate a database entry that can be used to generate request records related to hardware, software, or other provisionable resources (in the example represented in FIGS. 7A, 7B, and 7C, a “Standard Developer Laptop”).

### VII. Example Technical Improvements

The embodiments described herein provide technical solutions to technical problems. One technical problem being solved is the automated generation and fine-tuning of objects in a database (e.g., catalog objects used to obtain and organize user commands/inputs for later resolution) using generative machine learning models. In practice, this is problematic because of the computational expense associated with executing such machine learning models, the limited availability of training data for training such machine learning models, and the frequent presence of hallucinations or other unwanted content in the output of such models, especially where the models have been requested to output large amounts of diverse information, e.g., the many aspects of a database entry as described herein.

The embodiments herein overcome these limitations by using a natural language model to generate the database entries based on textual input directly from requestors, and also by allowing the requestor to provide feedback directly to the natural language model in order to modify the generated database entry. The ability to insert the user feedback directly, using the model, is enabled by the database entry being generated in an element-wise fashion as a plurality of elements, with each element corresponding to a respective input, description, fulfillment step, or other aspect of the database entry. The user selects a set of one or more of the elements and then the natural language model generates an output to modify (e.g., re-generate, update, delete) only the selected element(s). Since the user selection is used to generate a textual prompt to the natural language model to generate such an output, the user can also provide free-text input, or select from a number of enumeration textual options from a menu, that is added to the textual prompt in order to guide the model in generating the output. Further, since the user is able to select only those elements that exhibit hallucinations or other unwanted content, the overall cost of generating a database entry may be reduced (compared to, e.g., using the natural language model to automatically re-generate each and every one of the elements in order to reduce hallucinations or otherwise improve the elements) by relying on such user input to target the computational cost of the model onto those elements that actual require such efforts.

This element-wise operation also has the benefit of reducing computational cost, since the size of model, number of iterations, or other aspects of executing the model to accomplish such a relatively smaller task (i.e., the generation of an output for one or a few elements, rather than for all of the elements of a complete database entry) may be reduced. Further, using the natural language model to perform such a relatively more focused task (i.e., focusing on the contents of a few specific elements, rather than all of the elements of a database entry) can reduce the incidence of hallucinations. Indeed, the initial generation process for the complete database entry could be improved by, in the initial textual prompt used to initially generate the database entry, instructing the natural language model to only generate a list of elements of the database entry. The natural language model could then be operated to elaborate or otherwise generate content for each of the listed elements in turn. The reduction in computational cost for each of these executions of the model (owing to the relatively smaller and more focused nature of the task in each execution) and reduction in hallucinations or other unwanted erroneous content of database entries generated in such a fashion may result in an overall reduction in computational cost to generate the complete database entry, or at least may result in an increase in the quality of database entries generated thereby that justifies a small increase in overall computational cost.

The embodiments described herein also provide benefits by reducing the time and developer effort required to generate database entries, thereby allowing significantly more database entries to be generated. This can provide a technical benefit to the training of the underlying natural language model, since the training of large language models or other machine learning models can be very dependent on the amount of available training data. A training dataset that is wholly or partially composed of such model-generated database entries may provide addition benefits to model training. Such model-generated database entries are likely to be similar with respect to prose, style, tone, and organizational scheme. Thus, when training a natural language model based on such model-generated database entries (e.g., exclusively on model-generated database entries by discarding human-generated database entries from the training dataset), the model training process can focus on the more important aspects of the database entries and not be distracted by differences in style, prose, tone, organizational scheme, etc. between human developers.

Other technical improvements may also flow from these embodiments, and other technical problems may be solved. Thus, this statement of technical improvements is not limiting and instead constitutes examples of advantages that can be realized from the embodiments.

### VIII. Example Operations

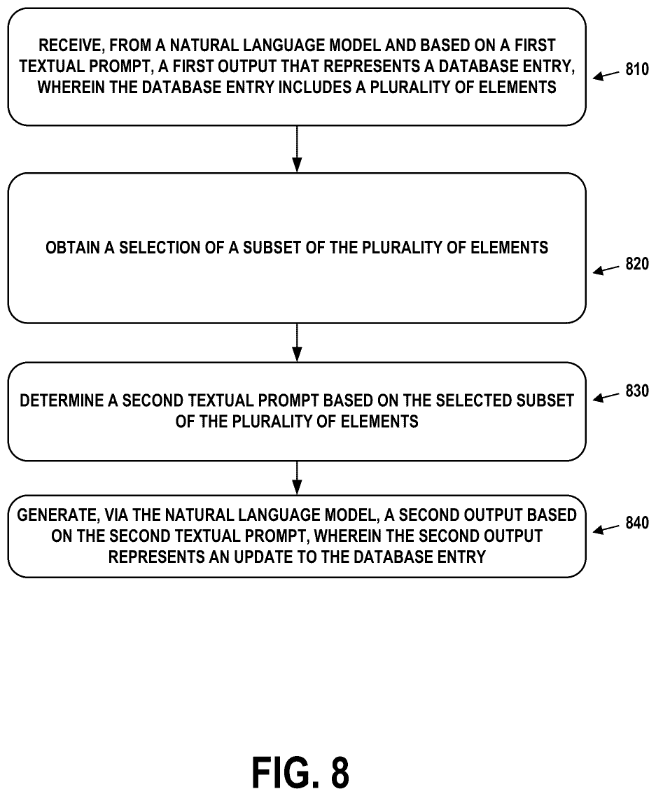

FIG. 8 is a flow chart illustrating an example embodiment. The process illustrated by FIG. 8 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 8 may be simplified by the removal of any one or more of the features shown therein. Further, these embodiments may be combined with features, aspects, and/or implementations of any of the previous figures or otherwise described herein.

The embodiments of FIG. 8 include receiving, from a natural language model and based on a first textual prompt, a first output that represents a database entry, wherein the database entry includes a plurality of elements (810).

The embodiments of FIG. 8 also include obtaining a selection of a subset of the plurality of elements (820).

The embodiments of FIG. 8 additionally include determining a second textual prompt based on the selected subset of the plurality of elements (830).

The embodiments of FIG. 8 further include generating, via the natural language model, a second output based on the second textual prompt, wherein the second output represents an update to the database entry (840).

The embodiments of FIG. 8 could include additional or alternative steps or elements. For example, the embodiments of FIG. 8 could additionally include updating the database entry according to the second output.

In some examples of the embodiments of FIG. 8, the second output represents an update to the selected subset of the plurality of elements of the database entry. In such examples, (i) obtaining the selection of the subset of the plurality of elements can include receiving, from a user via a user interface, an input indicating the selected subset and receiving, from the user via the user interface, a selection of one modification option from an enumerated set of modification options, and (ii) the one modification option of the enumerated set of modification options can be configured to receive free-form text from the user via the user interface. Additionally or alternatively, (i) obtaining the selection of the subset of the plurality of elements can include receiving, from a user via a user interface, an input indicating the selected subset of the plurality of elements and receiving, from the user via the user interface, a selection of one modification option from an enumerated set of modification options, and (ii) the enumerated set of modification options can include options to elaborate, simplify, regenerate, or delete one of the elements of the selected subset or to create a new element within the selected subset.

In some examples of the embodiments of FIG. 8, the natural language model can have been trained using a plurality of additional database entries related to operation of a particular managed network. For example, at least a portion of the plurality of additional database entries can have been generated by the natural language model prior to being trained using the plurality of additional database entries.

In some examples of the embodiments of FIG. 8, the plurality of elements can include a first element having a first data input, and the database entry can include an input sanitization criterion for the first data input. In such examples, the method could further include, prior to obtaining the selection of the subset of the plurality of elements (i) responsive to determining that the first element includes the first data input, determining a third textual prompt based on the first element; (ii) generating, via the natural language model, a third output based on the third textual prompt, wherein the third output represents the input sanitization criterion for the first data input; and (iii) updating the database entry according to the third output to include the input sanitization criterion for the first data input. Additionally or alternatively, the method could further include: (i) receiving, from a user via a user interface, a textual description of the input sanitization criterion; (ii) determining a third textual prompt based on the textual description, wherein the third textual prompt includes a request for a regular expression representing the input sanitization criterion as described by the textual description; (iii) generating, via the natural language model, a third output based on the third textual prompt, wherein the third output includes the regular expression that represents the input sanitization criterion; and (iv) updating the database entry according to the third output to include the regular expression as the input sanitization criterion for the first data input. In such examples, the method could further include: (i) receiving, from the user via the user interface, a test input; (ii) determining whether the test input satisfies the regular expression; and (iii) providing, via the user interface, an indication of whether the test input satisfies the regular expression.

In some examples of the embodiments of FIG. 8, the first output includes a listing of the elements of the plurality of elements, and the method further includes, for each element of the plurality of elements of the database entry: (i) determining a third textual prompt based on the element, wherein the third textual prompt includes at least one of a request to re-generate the element, a request to generate an input sanitization criterion for the element, or a request to elaborate the element; (ii) generating, via the natural language model, a third output based on the third textual prompt, wherein the third output represents an update to the element; and (iii) updating the element of the database entry according to the third output.

In some examples of the embodiments of FIG. 8, (i) obtaining the selection of the subset of the plurality of elements includes receiving a command to re-generate the selected subset of the plurality of elements, and (ii) determining the second textual prompt based on the selected subset of the plurality of elements comprises determining the second textual prompt to include a portion of the first output that represents the selected subset of the plurality of elements and a request to re-generate the elements represented by the portion of the first output.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving, from a natural language model and based on a first textual prompt, a first output that represents a database entry, wherein the database entry includes a plurality of elements;
obtaining a selection of a subset of the plurality of elements;
determining a second textual prompt based on the selected subset of the plurality of elements; and
generating, via the natural language model, a second output based on the second textual prompt, wherein the second output represents an update to the database entry.

2. The method of claim 1, further comprising updating the database entry according to the second output.

3. The method of claim 1, wherein the second output represents an update to the selected subset of the plurality of elements of the database entry.

4. The method of claim 3, wherein obtaining the selection of the subset of the plurality of elements comprises receiving, from a user via a user interface, an input indicating the selected subset and receiving, from the user via the user interface, a selection of one modification option from an enumerated set of modification options, wherein the one modification option of the enumerated set of modification options is configured to receive free-form text from the user via the user interface.

5. The method of claim 3, wherein obtaining the selection of the subset of the plurality of elements comprises receiving, from a user via a user interface, an input indicating the selected subset of the plurality of elements and receiving, from the user via the user interface, a selection of one modification option from an enumerated set of modification options, wherein the enumerated set of modification options includes options to elaborate, simplify, regenerate, or delete one of the elements of the selected subset or to create a new element within the selected subset.

6. The method of claim 1, wherein the natural language model has been trained using a plurality of additional database entries related to operation of a particular managed network.

7. The method of claim 6, wherein at least a portion of the plurality of additional database entries were generated by the natural language model prior to being trained using the plurality of additional database entries.

8. The method of claim 1, wherein the plurality of elements includes a first element having a first data input, and wherein the database entry includes an input sanitization criterion for the first data input.

9. The method of claim 8, wherein the method further comprises, prior to obtaining the selection of the subset of the plurality of elements:
responsive to determining that the first element includes the first data input, determining a third textual prompt based on the first element;
generating, via the natural language model, a third output based on the third textual prompt, wherein the third output represents the input sanitization criterion for the first data input; and
updating the database entry according to the third output to include the input sanitization criterion for the first data input.

10. The method of claim 8, further comprising:
receiving, from a user via a user interface, a textual description of the input sanitization criterion;
determining a third textual prompt based on the textual description, wherein the third textual prompt includes a request for a regular expression representing the input sanitization criterion as described by the textual description;
generating, via the natural language model, a third output based on the third textual prompt, wherein the third output includes the regular expression that represents the input sanitization criterion; and
updating the database entry according to the third output to include the regular expression as the input sanitization criterion for the first data input.

11. The method of claim 10, further comprising:
receiving, from the user via the user interface, a test input;
determining whether the test input satisfies the regular expression; and
providing, via the user interface, an indication of whether the test input satisfies the regular expression.

12. The method of claim 1, wherein the first output includes a listing of the elements of the plurality of elements, and wherein the method further comprises, for each element of the plurality of elements of the database entry:
determining a third textual prompt based on the element, wherein the third textual prompt includes at least one of a request to re-generate the element, a request to generate an input sanitization criterion for the element, or a request to elaborate the element;
generating, via the natural language model, a third output based on the third textual prompt, wherein the third output represents an update to the element; and
updating the element of the database entry according to the third output.

13. The method of claim 1, wherein obtaining the selection of the subset of the plurality of elements includes receiving a command to re-generate the selected subset of the plurality of elements, and wherein determining the second textual prompt based on the selected subset of the plurality of elements comprises determining the second textual prompt to include a portion of the first output that represents the selected subset of the plurality of elements and a request to re-generate the elements represented by the portion of the first output.

14. A non-transitory computer-readable medium, having stored thereon program instructions that, upon execution by a computing system, cause the computing system to perform operations comprising:
receiving, from a natural language model and based on a first textual prompt, a first output that represents a database entry, wherein the database entry includes a plurality of elements;
obtaining a selection of a subset of the plurality of elements;
determining a second textual prompt based on the selected subset of the plurality of elements; and
generating, via the natural language model, a second output based on the second textual prompt, wherein the second output represents an update to the database entry.

16. The non-transitory computer-readable medium of claim 14, wherein the natural language model has been trained using a plurality of additional database entries related to operation of a particular managed network, and wherein at least a portion of the plurality of additional database entries were generated by the natural language model prior to being trained using the plurality of additional database entries.

16. The non-transitory computer-readable medium of claim 14, wherein the first output includes a listing of the elements of the plurality of elements, and wherein the method further comprises, for each element of the plurality of elements of the database entry:
determining a third textual prompt based on the element, wherein the third textual prompt includes at least one of a request to re-generate the element, a request to generate an input sanitization criterion for the element, or a request to elaborate the element;
generating, via the natural language model, a third output based on the third textual prompt, wherein the third output represents an update to the element; and
updating the element of the database entry according to the third output.

17. The non-transitory computer-readable medium of claim 14, wherein obtaining the selection of the subset of the plurality of elements includes receiving a command to re-generate the selected subset of the plurality of elements, and wherein determining the second textual prompt based on the selected subset of the plurality of elements comprises determining the second textual prompt to include a portion of the first output that represents the selected subset of the plurality of elements and a request to re-generate the elements represented by the portion of the first output.

18. A system comprising:
one or more processors; and
memory, containing program instructions that, upon execution by the one or more processors, cause the system to perform operations comprising:
receiving, from a natural language model and based on a first textual prompt, a first output that represents a database entry, wherein the database entry includes a plurality of elements;
obtaining a selection of a subset of the plurality of elements;
determining a second textual prompt based on the selected subset of the plurality of elements; and
generating, via the natural language model, a second output based on the second textual prompt, wherein the second output represents an update to the database entry.

19. The system of claim 18, wherein the first output includes a listing of the elements of the plurality of elements, and wherein the method further comprises, for each element of the plurality of elements of the database entry:
determining a third textual prompt based on the element, wherein the third textual prompt includes at least one of a request to re-generate the element, a request to generate an input sanitization criterion for the element, or a request to elaborate the element;
generating, via the natural language model, a third output based on the third textual prompt, wherein the third output represents an update to the element; and
updating the element of the database entry according to the third output.

20. The system of claim 18, wherein obtaining the selection of the subset of the plurality of elements includes receiving a command to re-generate the selected subset of the plurality of elements, and wherein determining the second textual prompt based on the selected subset of the plurality of elements comprises determining the second textual prompt to include a portion of the first output that represents the selected subset of the plurality of elements and a request to re-generate the elements represented by the portion of the first output.
